(19) United States
(12) Patent Application Publication
(10) Pub. No.: US 2002/0088673 A1
(43) Pub. Date: Jul. 11, 2002

(54) Railcar anti-skid brakes

(75) Inventor: Roy Malac, Indialantic, FL (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: General Electric Company

(21) Appl. No.: 09/755,214

(22) Filed: Jan. 5, 2001

(51) Int. Cl. F16D 66/00

(52) U.S. Cl. 188/1.11 R

(57) ABSTRACT

An apparatus and method for incorporating a feedback mechanism (24) into a train railcar wheel braking system (10) to regulate applied braking force. The feedback mechanism (24) provides information to an electronically controlled pneumatic braking system (10) sufficient to detect impending wheel slip or skid. Responsive to the wheel slip/skid information, a brake control processor (18) modulates the braking force applied to the train railcar wheel system to enable the braking system (10) to apply a braking force without damaging the railcar wheel system or rails over which the railcar wheels are traveling.

### BACKGROUND OF THE INVENTION

The present invention relates to vehicle braking systems, and in particular, to an anti-skid braking system for use on train railcar wheels to detect impending wheel skid or slip, and to modulate the applied braking force to prevent railcar wheel skidding or slipping.

Conventional railcar braking systems typically comprise a pneumatic brake valve configured to detect changes in air pressure in a brake pipe extending the length of the train. Detected changes in air pressure in the brake pipe are interpreted as commands for braking activity. An alternative railcar braking system employs an electronic control signal to actuate the railcar brakes. The electronic control signal may either be sent from a train controller to the individual railcars via a wire, or via a wireless communications link. Each individual railcar receives the braking control signals at a car control device which processes the received signals and controls the application of the railcar brakes.

It is well known to those skilled in the art that railcar overbraking and ensuing railcar wheel lockup and wheel sliding must be avoided. This is because resultant flat spots and damage to the railcar wheels may occur during braking. On heavily loaded railway vehicles, there is the possibility that an underbraking condition may result in longer braking distances. This can cause a railway train to over-run its normal stopping point at a station or a block section.

To avoid overbraking and underbraking conditions, conventional brakes on railcars apply a fixed braking force to the brake shoes on each wheel in response to a train operator signals. Some railcars are equipped with load weight systems to modify the applied braking force depending upon the load/empty state of the railcar. These systems do not have a feedback system to modulate the applied braking force if the railcar wheel is at the point of impending slip. Conventional braking systems further do not have the capability to adjust the braking force in real time other than in response to the load state of the railcar. Lacking an impending slip feedback system, wheel skid or slip can occur which may result in frictional damage to the railcar wheels, damage to the rails over which the railcar wheel is traveling, and potentially cause severe train braking problems including railcar derailment.

### BRIEF SUMMARY OF THE INVENTION

Briefly stated, the present invention provides an apparatus and method for incorporating a feedback mechanism into a train railcar wheel system to detect impending wheel slip or skid. The feedback mechanism provides information to an electronically controlled pneumatic braking system, permitting modulation of the braking force applied to the train railcar wheel system. This enables the system to apply the maximum possible braking force without damaging the railcar wheel system or rails over which the railcar wheels are traveling.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a block diagram of the railcar braking system components; and

FIG. 2 is a flowchart illustrating the railcar braking system anti-skid algorithm.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The terms acceleration and deceleration as used throughout this description are understood to refer to a change in velocity. Acceleration is considered as a positive change in velocity, while deceleration is a negative change in velocity. Accordingly, the terms may be used interchangeably throughout this description, and those of ordinary skill in the art will readily recognize that a negative acceleration is a deceleration, and that a negative deceleration is acceleration.

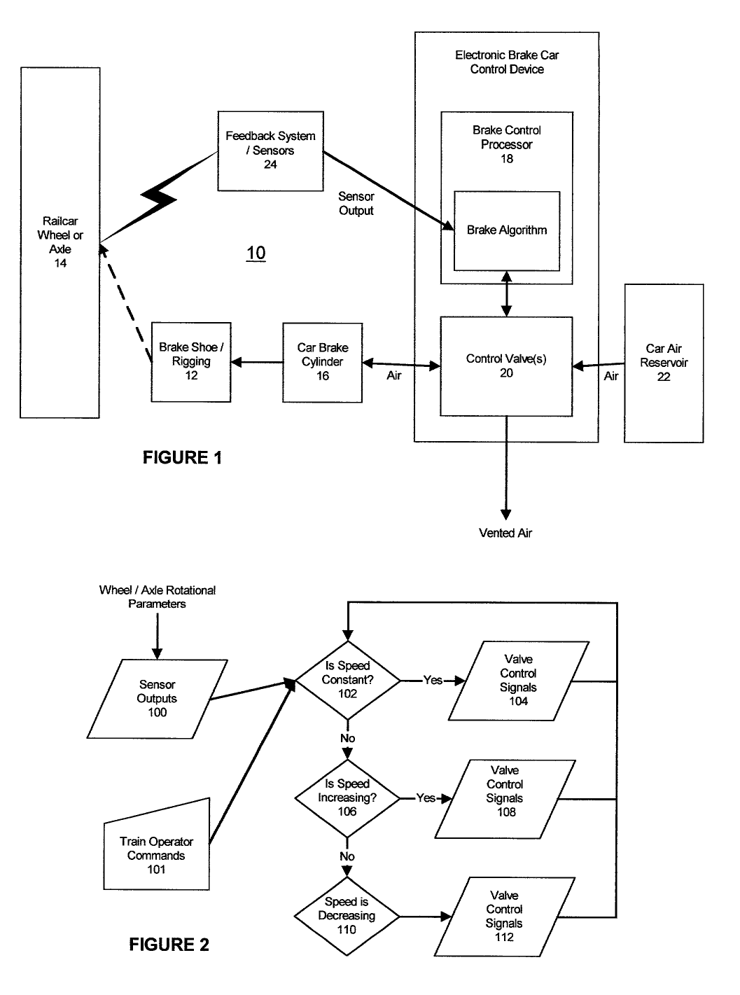

Turning to FIG. 1, railcar wheel braking systems 10 comprise one or more wheel brake shoes or braking rigs 12 configured to apply a braking force against a braking surface on a railcar wheel 14. Each wheel brake shoe 12 is actuated by a pneumatic brake cylinder 16 in response to pneumatic pressure. The level of pneumatic pressure in the braking system 10 is regulated by a brake control processor 18 through the actuation of a control valve 20 between the pneumatic brake cylinder 16 and a supply of compressed air 22.

The presence of the brake control processor 18 allows for the use of a feedback system 24 to provide the brake control processor 18 with information indicative of one or more wheel rotational parameters for each railcar wheel 14, such as wheel rotational velocity and wheel rotational acceleration or deceleration. The brake control processor 18 is configured to utilize the information received from the feedback system 24 to detect when wheel slip or skid, i.e. a wheel lockup condition, is imminent at each railcar wheel 14. In response to the detection of imminent wheel slip or skid for a particular railcar wheel 14, the brake control processor 18 is further configured to modulate the pneumatic pressure in the pneumatic brake cylinder 16 associated with the railcar wheel 14 to regulate the braking force applied to the railcar wheel 14 by the brake shoe 12. Modulation of the pneumatic pressure to regulate the braking force applied to the railcar wheel 14 by the brake shoe 12 functions to provide an “anti-lock” braking action to the individual railcar wheels 14. Preventing wheel slip/skid permits the brake control processor 18 to apply the maximum braking force to the railcar wheel 14 without damaging the railcar wheel or the rail over which it is traveling.

The feedback system 24 provides the brake control processor 18 with information indicative of one or more wheel rotational parameters, and includes at least one wheel rotational speed sensor. Railcar wheels 14 and their associated axles comprise a single entity for a standard railcar. Thus, wheel rotation and axle rotation are equivalent, enabling wheel rotational speed sensors to be placed on the railcar in a location which is convenient to measure either the wheel rotation directly, or the axle rotation. Numerous designs of wheel rotational speed sensors are presently known. Such sensors generally consist of a rotating part, mounted on the wheel or axle shaft in close proximity to a stationary part. The rotating part, or “tone ring” has features which can be sensed as they pass the stationary part. Such features are typically ferromagnetic teeth, as on a gear, or magnetic poles which have been applied to the part. The stationary part includes a transducer which detects the passing of the features as the tone ring rotates. The detection is indicated by an electrical signal emitted by the transducer. The transducer may be a variable reluctance device, Hall effect sensor, magneto-restrictive device, or of some other construction, such as an optical strobe. Generally, the transducer is a device which senses magnetic fields or changing magnetic fields. Variable reluctance transducers are referred to as “passive” sensors in that they generate a voltage without being energized by an external source. Active sensors such as a Hall effect sensor are energized by an externally applied voltage and provide output information relating the one or more wheel rotational parameters responsive to the magnetic fields passing through them.

During braking operations, the brake control processor 18 monitors the sensor outputs from each feedback system 24 associated with each wheel 14 of the railcar, and compares the sensor outputs with the train operator commanded braking state to identify an action to be taken. The operator commanded braking state may represent a no-brake condition, an increased brake condition, a hold brake condition, or a release brake condition. Alternatively, the operator commanded braking state may simply represent a desired braking pressure value.

In response to the operator commanding the application of brakes or the increase in braking pressure, the brake control processor 18 is configured to direct the braking system 12 to increase the pneumatic pressure applied to the brake shoes at each railcar wheel 14, thereby applying a braking force to the railcar wheels. Additionally, the brake control processor 18 receives signals from the feedback system 24 indicative of one or more rotational parameters of each of the railcar wheels 14.

In the preferred embodiment, the feedback system 24 compares rotational speed measurements V_{R1} . . . V_{Rn} taken at two or more points in time to identify wheel rotational acceleration or deceleration (dV_{R}/dt). Alternatively, the feedback system may directly measure wheel rotational acceleration or deceleration and provide a representative signal to the brake control processor 18.

As seen in FIG. 2, the brake control processor 18 receives the feedback system output (Box 100) to identify if the wheel rotational speed V_{R} is constant (Box 102). If the wheel rotational speed is observed to be constant, a first adjustment to the applied braking force (Box 104) is directed by the brake control processor 18. If the wheel rotational speed is not constant, the brake control processor determines if the wheel rotational speed is increasing (Box 106) and a second adjustment to the applied braking force (Box 108) is directed by the brake control processor 18. Finally, if the brake control processor determines if the wheel rotational speed is decreasing (Box 110), a third adjustment to the applied braking force (Box 112) is directed by the brake control processor 18. The cycle of observation and adjustment is repeated until either the train operator commands a different brake state (i.e. more brakes, less brakes, or no brakes), or until the train is stopped.

In a first embodiment of the present invention, an identified decreasing wheel rotational speed is compared by the brake control processor 18 to a lookup table of previously stored acceptable rates of wheel rotational speed decreases indexed to operator brake application commands. If the identified decrease in wheel rotational speed is lower than the acceptable rate indicated in the table for the current brake application command state, the brake control processor 18 increases the braking force applied to the railcar wheel 14. Conversely, if the identified decrease in wheel rotational speed is greater than the acceptable rate indicated in the table for the current brake application command state, wheel slip or skid is imminent, and the brake control processor 18 momentarily vents some air from the brake cylinder 16 to reduce the braking force applied to the railcar wheel 14.

If only wheel rotational speed, V_{R} or acceleration/deceleration, dV/dt, measurements are used individually, there exist ambiguous states in which the brake control processor 18 may not recognize imminent wheel skid or slip. Accordingly, in an alternative embodiment, the brake control processor 18 is configured to observe wheel rotational speed and wheel acceleration/deceleration to ensure that the wheel acceleration/deceleration is either constant or is within an acceptable range defined in a lookup table, indexed by the wheel rotational speed. It has been determined that if the wheel deceleration is observed to be very rapid, wheel slip or skid is imminent, the brake control processor 18 is configured to momentarily vent air from the brake cylinder 16 in order to momentarily reduce the braking force applied to the railcar wheel 14, and thus prevent wheel slip or skid.

In either embodiment, the process of applying a braking force and measuring the wheel rotational parameters (speed and acceleration/deceleration) for comparison with expected parameters is repeated until the wheel has been brought to a complete stop without slip or skid, or until the train operator signals a change in the braking command state (i.e. application of more brakes, less brakes, or no brakes).

If during a brake application, the brake control processor 18 receives signals to indicate one or more of the railcar wheels 14 has reached a braking limit, as indicated by a predetermined change in one or more wheel rotational parameters, the brake controller 18 identifies a wheel lockup condition, and directs the braking system 12 to reduce the braking force applied to the associated railcar wheel 14. In the preferred embodiment, the braking force is reduced by reducing the pneumatic pressure applied to the associated brake shoe 12 from the brake cylinder 16.

Alternatively, if the received signals indicate that one or more of the railcar wheels 14 has not yet reached a braking limit, as indicated by a predetermined change in one or more wheel rotational parameters, the brake controller 18 continues to direct the braking system 12 to increase the pneumatic pressure applied to the railcar wheel brake shoe, thereby increasing the braking force to the railcar wheel 14.

In this manner, the brake controller 18 is configured to utilize the signals received from the feedback system to regulate the braking force applied to each railcar wheel 14 such that each railcar wheel operates during braking at or near a braking limit defined by the point at which the railcar wheel begins to slip or skid for so long as is indicated by the received brake control signal from the train operator, or until the train is stopped.

Those of ordinary skill in the art will readily recognize that the brake control system of the present invention may be adapted for use with variety of railcar wheel braking systems, and is not limited to braking systems employing pneumatic pressure as a braking force. For example, the brake control system of the present invention may be utilized in railcar wheel braking systems employing electromagnetic brakes or hydraulic brakes.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A railcar braking system, comprising:
a brake mechanism configured to apply a variable braking force to a railcar wheel;
at least one railcar wheel rotation sensor configured to detect at least one wheel rotational parameter of said railcar wheel; and
a brake controller in communication with said at least one railcar wheel rotation sensor to receive said detected at least one wheel rotational parameter, said brake controller configured to control said brake mechanism to regulate said variable braking force responsive to said at least one detected wheel rotational parameter.

2. The railcar braking system of claim 1 wherein said railcar wheel rotation sensor is a Hall effect sensor.

3. The railcar braking system of claim 1 wherein said brake mechanism is a pneumatic brake mechanism, and said brake controller is configured to regulate pneumatic pressure in said pneumatic brake mechanism.

4. The railcar braking system of claim 1 wherein said brake controller utilizes said at least one detected wheel rotational parameter to identify a wheel lockup condition of said railcar wheel.

5. The railcar braking system of claim 4 wherein said at least one detected wheel rotational parameter is wheel rotational acceleration.

6. The railcar braking system of claim 4 wherein said at least one detected wheel rotational parameter is wheel rotational speed.

7. The railcar braking system of claim 1 wherein said brake controller is configured with a table of predetermined wheel rotational parameters for comparison with said detected at least one wheel rotational parameter.

8. A method for regulating braking force applied to a railcar wheel, comprising:
applying a braking force to said railcar wheel;
observing at least one wheel rotational parameter of said railcar wheel; and
responsive to said observed wheel rotational parameter of said railcar wheel, adjusting said applied braking force to said railcar wheel.

9. The method of claim 8 wherein said at least one rotational parameter of said railcar wheel is acceleration.

10. The method of claim 8 wherein said at least one rotational parameter of said railcar wheel is rotational velocity.

11. The method of claim 8 wherein said applied braking force is adjusted responsive to said observed rotational parameter of said railcar wheel indicating the presence of wheel lockup.

12. The method of claim 8 wherein responsive to said observed wheel rotational parameter of said railcar wheel, a predetermined wheel rotational value is identified and compared with said observed wheel rotational parameter prior to adjusting said applied braking force, said comparison regulating said adjustment.

13. The method of claim 8 wherein said applied braking force is adjusted responsive to a received brake command signal.

14. A method for regulating braking force applied to a railcar wheel, comprising:
receiving a brake command signal;
applying a braking force to said railcar wheel responsive to said received brake command signal;
measuring wheel rotational parameters of said railcar wheel;
responsive to said measured wheel rotational parameters indicating a constant wheel rotational speed, applying a first braking force adjustment;
responsive to said measured wheel rotational parameters indicating a increasing wheel rotational speed, applying a second braking force adjustment;
responsive to said measured wheel rotational parameters indicating a decreasing wheel rotational speed, applying a third braking force adjustment; and
repeating the steps of measuring and responding as required by said received brake command signal.
